(19) United States
(12) Patent Application Publication
(10) Pub. No.: US 2020/0346275 A1
(43) Pub. Date: Nov. 5, 2020

(54) WIRE BENDING APPARATUS INCLUDING BUSHING GRIP

(71) Applicants: YOUN HO JUNG, Seoul (KR); JAE WOONG JUNG, Seoul (KR)

(72) Inventors: YOUN HO JUNG, Seoul (KR); JAE WOONG JUNG, Seoul (KR); KWANG GU BAEK, Gyeonggi-do (KR); YOON SANG SHIN, Seoul (KR)

(21) Appl. No.: 16/401,478

(22) Filed: May 2, 2019

(51) Int. Cl. B21F 7/00; A61C 7/02

(52) U.S. Cl. CPC B21F 7/00; A61C 7/026

(57) ABSTRACT

A wire bending apparatus includes a base portion, a supplying portion configured to move the orthodontic wire along a length direction of the orthodontic wire, a bushing holding portion configured to hold at least a portion of a distal end of the supplied orthodontic wire to restrict the orthodontic wire from moving in a width direction of the orthodontic wire, and a bending portion which is positioned on the base portion so as to be rotatable about a rotation center axis and bends the portion of the distal end of the orthodontic wire held by the bushing holding portion to a predetermined angle with respect to a supply direction of the orthodontic wire as the bending portion is rotated.

### BACKGROUND

### 1. Field

The following description relates to a wire bending apparatus including a bushing grip.

### 2. Description of Related Art

Recently, orthodontic treatment has become increasingly common in addition to medical care required to improve oral hygiene and maintain healthy teeth. Orthodontic treatment refers to the remedial actions that not only align crooked teeth, but also correct various skeletal incompatibilities in the teeth and mouth that may occur during the growth process so that the teeth can perform their normal functions. In addition, the treatment may result in a healthy oral tissue and a more beautiful facial appearance.

In this case, an orthodontic appliance fabricated with orthodontic wires is generally used in orthodontic treatment, wherein the structure and shape of the orthodontic wires may be formed differently according to a tooth structure, such as the tooth arrangement and shape of an orthodontic patient.

That is, the orthodontic appliance should be precisely shaped according to the oral structure of the patient to be treated, and the shaping of the orthodontic wires is often manually carried out by a skilled technician.

However, when the orthodontic appliance is shaped manually by a skilled technician, there was a problem in that quality may vary depending on the skill of the technician, and the orthodontic appliance accounted for a large portion of the cost of orthodontic treatment due to the cost incurred by manual labor of the skilled technician and time burden.

Accordingly, in order to address the cost increase due to the manual shaping of the orthodontic appliance, a bending apparatus which automatically bends and shapes an orthodontic wire has been proposed as disclosed in Korean Patent Registration No. 10-1629136.

However, when an orthodontic wire is formed into a helical shape by at least two wire members twisted, the helical shape of the orthodontic wire may cause unintended three-dimensional twisting or bending of the orthodontic wire in the bending process, and an orthodontic appliance is fabricated in an unintended shape.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide a wire bending apparatus including a bushing grip which can bend an orthodontic wire by a predetermined angle at predetermined intervals of length and thereby automatically fabricate an orthodontic appliance of a predetermined shape, and a method of controlling a bending angle.

In addition, the disclosed embodiments are intended to provide a wire bending apparatus including a bushing grip which can prevent an orthodontic wire from being twisted at the time of bending the orthodontic wire by a bending portion.

Also, the disclosed embodiments are intended to provide a wire bending apparatus including a bushing grip which can prevent possibility of an orthodontic wire being twisted in a direction non-parallel to a plane of rotation of a bending portion at the time of bending the orthodontic wire.

In one general aspect, a wire bending apparatus including a bushing grip for bending an orthodontic wire of a predetermined length into a predetermined shape includes a base portion; a supplying portion configured to move the orthodontic wire along a length direction of the orthodontic wire; a bushing holding portion configured to hold at least a portion of a distal end of the supplied orthodontic wire to restrict the orthodontic wire from moving in a width direction of the orthodontic wire; and a bending portion which is positioned on the base portion so as to be rotatable about a rotation center axis and bends the portion of the distal end of the orthodontic wire held by the bushing holding portion to a predetermined angle with respect to a supply direction of the orthodontic wire as the bending portion is rotated, wherein the bushing holding portion is formed to be hollow and includes a holding hole through which the orthodontic wire is allowed to pass.

A diameter of the holding hole may have a size corresponding to the largest width among widths on a plane orthogonal to the length direction of the orthodontic wire.

The bushing holding portion may include a bushing grip in which the holding hole is formed and the bushing grip may be formed as a single structure that is not separated or disassembled.

The orthodontic wire may be moved while overcoming friction with the holding hole during the supplying by the supplying portion.

The orthodontic wire may include at least two wire members and each of the at least two wire members may be formed in a helix shape along a center axial length direction of the orthodontic wire.

The at least two wire members may be twisted with each other along the center axial length direction of the orthodontic wire.

The orthodontic wire may include a first wire and a second wire which each are formed in a helix shape and are twisted with each other along the center axial length direction of the orthodontic wire.

The bending portion may include a rotary member rotatable about the rotation center axis by a predetermined angle with respect to the base portion and a bending member formed on the rotary member to be eccentric to the rotation center axis and the bending member may bend the portion of the distal end of the orthodontic wire as the bending member is rotated while being in contact with the distal end of the orthodontic wire.

Other features and aspects will be apparent from the following detailed description, the drawings, and the claims.

### BRIEF DESCRIPTION OF THE DRAWINGS

FIG. 1 is a diagram illustrating a wire bending apparatus including a bushing grip according to one embodiment of the present disclosure.

FIG. 2 is a partial enlarged view of portion A of the wire bending apparatus including a bushing grip according to one embodiment of the present disclosure.

FIG. 3 is a diagram illustrating an orthodontic wire to be bent in a wire bending apparatus including a bushing grip according to one embodiment of the present disclosure.

FIG. 4 is a transverse cross-sectional view of a bushing grip of a wire bending apparatus including the bushing grip according to one embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, specific embodiments of the present disclosure will be described in accordance with the following drawings, however, they are only exemplary embodiments of the disclosure, and the present disclosure is not limited thereto.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context.

The spirit and scope of the disclosure are defined by the appended claims. The following embodiments are only made to efficiently describe the progressive technological scope of the present disclosure to those skilled in the art.

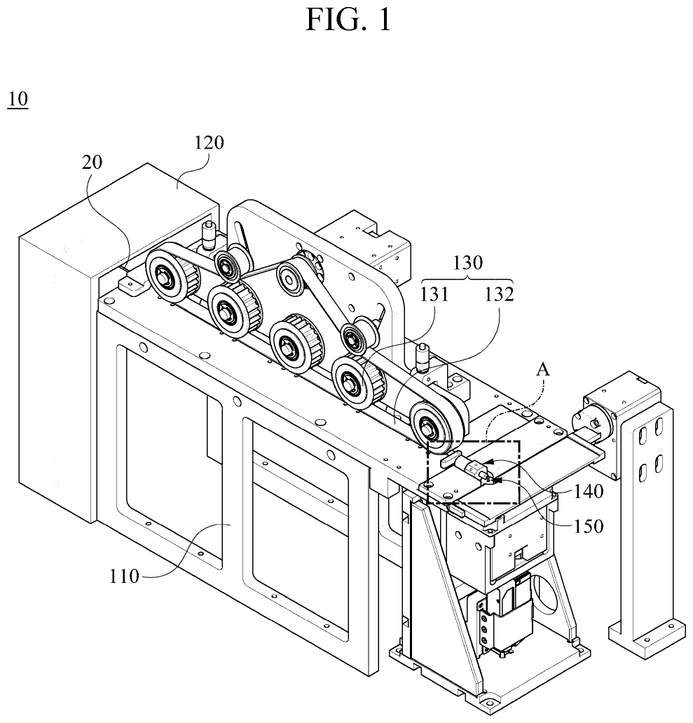

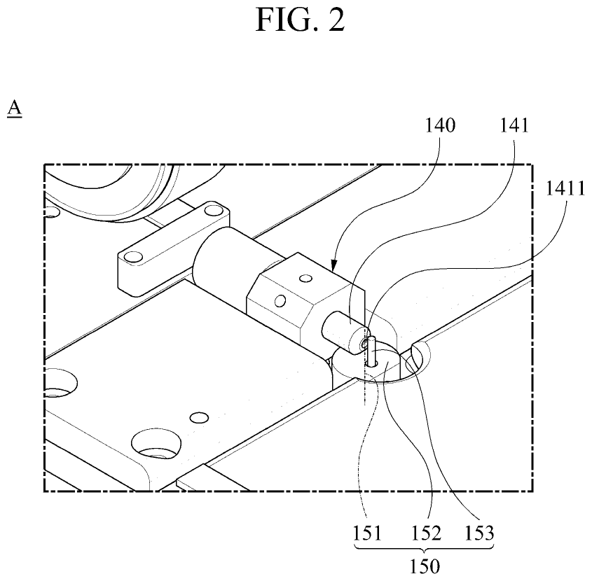

FIG. 1 is a diagram illustrating a wire bending apparatus 10 including a bushing grip according to one embodiment of the present disclosure, and FIG. 2 is a partial enlarged view of portion A of the wire bending apparatus 10 including a bushing grip according to one embodiment of the present disclosure.

Referring to FIGS. 1 and 2, the wire bending apparatus 10 including a bushing grip according to one embodiment of the present disclosure may bend an orthodontic wire 20 of a predetermined length into a predetermined shape. Specifically, the wire bending apparatus 10 including a bushing grip according to one embodiment of the present disclosure may include a base portion 110 capable of seating on the ground or a table, a supplying portion 120 configured to supply the orthodontic wire 20 to one side, a bushing holding portion 140 formed on the base portion 110, and a bending portion 150.

More specifically, the above-described supplying portion 120 may linearly move the orthodontic wire 20 in one direction along the length direction of the orthodontic wire 20. In this case, the supplying portion 120 may move the orthodontic wire 20 toward the bushing holding portion 140.

The above-described bushing holding portion 140 may hold at least a portion of a distal end of the orthodontic wire 20, which is supplied by the supplying portion 120, in a feeding direction and may restrict the movement of the orthodontic wire 20 in a thickness direction. That is, the orthodontic wire 20 is restricted from moving in the thickness direction by the bushing holding portion 140 and hence is allowed to move only in a length direction. Further, the bushing holding portion 140 may be formed to be hollow and may include a holding hole 1411 through which the orthodontic wire 20 is allowed to pass.

The bending portion 150 described above may be positioned on the base portion 110 so as to be rotatable about a rotation center axis 151. In addition, as the bending portion 150 is rotated, the portion of the distal end of the orthodontic wire 20 held by the bushing holding portion 140 may be bent to a predetermined angle with respect to a supply direction of the orthodontic wire 20. The bending of the orthodontic wire 20 by the bending portion 150 will be described in detail below.

Meanwhile, the wire bending apparatus 10 including a bushing grip according to one embodiment of the present disclosure may further include a guide portion 130 interposed between the supplying portion 120 and the bushing holding portion 140 to linearly guide the orthodontic wire 20 drawn out from the supplying portion 120 to the bushing holding portion 140.

Specifically, the guide portion 130 may include a plurality of feed pulleys 131 arranged along the supply direction of the orthodontic wire and a feed belt 132 which is positioned around the feed pulleys 131 and is conveyed in a predetermined direction according to the rotation of each of the plurality of feed pulleys 131. In this case, an outer surface of the feed belt 132 in a side opposite to the feed pulleys 131 may be positioned downward and the orthodontic wire fed by the supplying portion 120 may be positioned in closed contact with a lower surface of the feed belt 132. That is, as the feed belt 132 is conveyed in a predetermined direction, the orthodontic wire in close contact with the feed belt 132 may be linearly fed in a predetermined direction by friction of the feed belt 132.

Further, the bushing holding portion 140 may include a bushing grip 141 in which the above-described holding hole 1411 and the bushing grip 141 may be formed as a single structure that is not separated or disassembled. In this case, the bushing grip 141 may have a predetermined length and may be formed in a hollow cylinder shape having the holding hole 1411 formed on the central portion thereof. In addition, the holding hole 1411 may be formed with a uniform diameter along the length direction.

In addition, a distal end of the bushing grip 141 in a side of the bending portion 150 may be positioned above the bending portion 150. Preferably, the distal end of the bushing grip 141 in the side of the bending portion 150 may be positioned above in a direction perpendicular to the ground of a rotary member 152 which will be described below. That is, a horizontal distance between the end of the bushing grip 141 and a bending member 153 which will be described below may be minimized at the distal end of the orthodontic wire 20 drawn out from the holding hole 1411.

In addition, the bending portion 150 described above may include the rotary member 152 rotatable about the rotation center axis 151 by a predetermined angle with respect to the base portion 110 and the bending member 153 formed on the rotary member 152 to be eccentric to the rotation center axis 151. Specifically, the rotary member 152 may include the rotation center axis 151 which is rotated by a driving portion (not shown) and the rotary member 152 may rotate about the rotation center axis 151 by a predetermined angle as the rotation center axis 151 rotates. In this case, the rotation center axis 151 may be coupled to a center portion of the rotary member 152.

In addition, the bending member 153 may be in contact with a portion of the distal end of the orthodontic wire 20 and may bend the portion of the distal end of the orthodontic wire as the bending member 153 is rotated while being in contact with the distal end of the orthodontic wire 20.

More specifically, the bending member 153 is formed on the rotary member 152 to be eccentric to the rotation center axis 151 so that the bending member 153 may rotate by a predetermined angle about the rotation center axis 151 as the rotary member 152 rotates by a predetermined angle. The bending member 153 described above may be in contact with a portion of the distal end of the orthodontic wire 20 which is restricted by the bushing holding portion 140 from moving in a width direction (preferably, a portion of the distal end of the orthodontic wire 20 passing through the holding hole 1411 and protruding out of the bushing holding portion 140).

In this case, the bending member 153 may be rotated in a predetermined angle range about the rotation center axis 151 while being in contact with the portion of the distal end of the orthodontic wire 20 and thereby may bend the portion of the distal end of the orthodontic wire 20 to the predetermined angle. In addition, the bending member 153 is rotated on a plane of rotation of the rotary member 152 so that the portion of the distal end of the orthodontic wire 20 can be bent by the same angle as a rotation angle of the bending member 153 on a plane parallel to the plane of rotation of the bending portion 150.

Further, the bending member 153 described above may be formed as a shaft protruding upward from the rotary member 152. That is, the bending member 153 may include an outer circumferential surface of a predetermined diameter and may bend the orthodontic wire 20 only on the plane of rotation of the bending portion 150 irrespective of the contact position with the orthodontic wire 20.

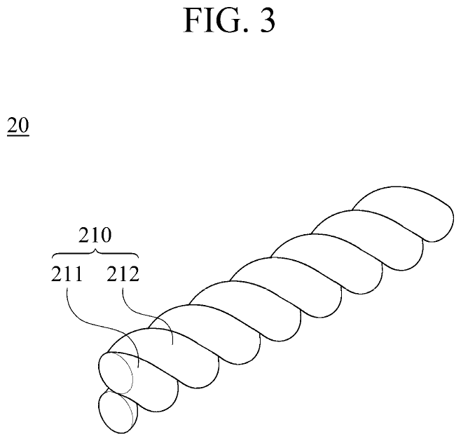

FIG. 3 is a diagram illustrating an orthodontic wire 20 to be bent in a wire bending apparatus 10 including a bushing grip according to one embodiment of the present disclosure.

Referring to FIG. 3, the orthodontic wire 20 described above may include at least two wire members 210. Each of the at least two wire members 210 may be formed in a helix shape along a center axial length direction of the orthodontic wire 20. Specifically, each of the at least two wire members 210 may be formed in a helix shape along the length direction so as to encircle the center axis of the orthodontic wire 20, and the at least two wire members 210 may overlap and be in surface contact with each other and be formed into a helix. That is, the at least two wire members 210 may be twisted with each other along the center axial length direction of the orthodontic wire 20.

Meanwhile, preferably, the at least two wire members 210 may include a first wire 211 and a second wire 212. The first wire 211 and the second wire 212 may each be formed into a helix and may be twisted with each other along the center axial length direction of the orthodontic wire 20. In other words, the orthodontic wire 20 may be formed by twisting the first wire 211 and the second wire 212 with each other along the center axial length direction.

That is, the first wire 211 and the second wire 212 may be tilted with respect to a plane orthogonal to the center axis of the orthodontic wire 20 and be in contact with each other. In addition, a spacing may be formed on outer surfaces of the first wire 211 and the second wire 212, except for the contact surface between the first wire 211 and the second wire 212.

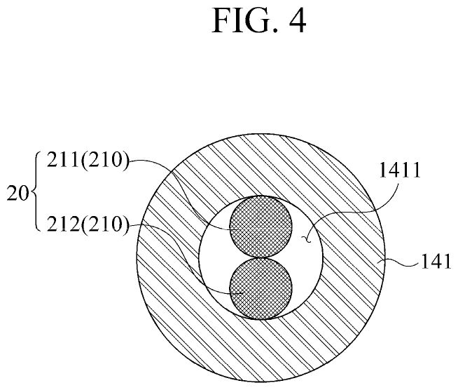

FIG. 4 is a transverse cross-sectional view of a bushing grip 141 of a wire bending apparatus 10 including the bushing grip according to one embodiment of the present disclosure.

Referring to FIG. 4, the diameter of the holding hole 1411 formed in the bushing grip 141 described above may have a size corresponding to the largest width among widths on a plane orthogonal to the length direction of the orthodontic wire 20.

Specifically, the largest width (preferably the sum of the diameters of the first wire 211 and the second wire 212) among the widths traversing the center axis on the plane orthogonal to the center axis of the orthodontic wire 20 may have a size corresponding to the diameter of the holding hole 1411.

In this case, the aforementioned “corresponding size” may refer to the same size but is not limited thereto, and may refer to a size that allows the orthodontic wire 20 to pass through the holding hole 1411 while overcoming friction due to the contact with the holding hole 1411 when the supplying portion 120 linearly moves the orthodontic wire 20 in one direction. That is, the orthodontic wire 20 may be moved to the bending portion 150 while overcoming friction with the holding hole 1411 and being restricted by the busing grip 141 from moving in the width direction during the supplying by the supplying portion 120.

In addition, an outermost side of each of the above-described at least two wire members 210 (preferably, the first wire 211 and the second wire 212) in a radial direction with respect to the center axis of the orthodontic wire 20 may be brought into surface contact with the holding hole 1411. A contact surface between each of the at least two wire members 210 and an inner peripheral surface of the holding hole 1411 may be formed in a helical shape along the length direction of the orthodontic wire 20 and may be tilted with respect to a plane (i.e., a transverse cross-section of the bushing grip 141) orthogonal to the length direction of the bushing grip 141.

That is, the orthodontic wire 20 and the holding hole 1411 form at least two helical surface contacts along the length direction of the bushing grip 141 so that a frictional force between the holding hole 1411 and the orthodontic wire 20, in a circumferential direction may be increased. Therefore, it is possible to greatly restrict the rotation about the center axis in the length direction of the orthodontic wire 20 and to prevent the orthodontic wire 20 from being twisted in a spiral direction at the time of bending by the bending portion 150.

That is, it is possible to prevent the orthodontic wire 20 from being twisted or bent in a direction inclined with respect to the plane of rotation of the bending portion 150. The orthodontic wire 20 may be allowed to rotate by the same angle as the rotation angle of the bending portion 153 only on a plane parallel to the plane of rotation of the bending portion 150.

According to the embodiments of the present invention, it is possible to bend an orthodontic wire by a predetermined angle at predetermined intervals of length and thereby automatically fabricate an orthodontic appliance of a predetermined shape.

In addition, according to the embodiments of the present disclosure, it is possible to prevent an orthodontic wire from being twisted at the time of bending the orthodontic wire by a bending portion.

Also, according to the embodiments of the present invention, it is possible to prevent possibility of an orthodontic wire being twisted in a direction non-parallel to a plane of rotation of a bending portion at the time of bending the orthodontic wire.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A wire bending apparatus, comprising:
a bushing grip for bending an orthodontic wire of a predetermined length into a predetermined shape;
a base portion;
a supplying portion configured to move the orthodontic wire along a length direction of the orthodontic wire;
a bushing holding portion configured to hold at least a portion of a distal end of the supplied orthodontic wire to restrict the orthodontic wire from moving in a width direction of the orthodontic wire; and
a bending portion which is positioned on the base portion so as to be rotatable about a rotation center axis and bends the portion of the distal end of the orthodontic wire held by the bushing holding portion to a predetermined angle with respect to a supply direction of the orthodontic wire as the bending portion is rotated,
wherein the bushing holding portion is formed to be hollow and includes a holding hole through which the orthodontic wire is allowed to pass.

2. The wire bending apparatus of claim 1, wherein a diameter of the holding hole has a size corresponding to a largest width among widths on a plane orthogonal to the length direction of the orthodontic wire.

3. The wire bending apparatus of claim 2, wherein the bushing holding portion includes a bushing grip in which the holding hole is formed and the bushing grip is formed as a single structure that is not separated or disassembled.

4. The wire bending apparatus of claim 1, wherein the orthodontic wire is moved while overcoming friction with the holding hole during the supplying by the supplying portion.

5. The wire bending apparatus of claim 1, wherein the orthodontic wire includes at least two wire members and each of the at least two wire members is formed in a helix shape along a center axial length direction of the orthodontic wire.

6. The wire bending apparatus of claim 5, wherein the at least two wire members are twisted with each other along the center axial length direction of the orthodontic wire.

7. The wire bending apparatus of claim 5, wherein the orthodontic wire includes a first wire and a second wire which each are formed in a helix shape and are twisted with each other along the center axial length direction of the orthodontic wire.

8. The wire bending apparatus of claim 1, wherein the bending portion includes a rotary member rotatable about the rotation center axis by a predetermined angle with respect to the base portion and a bending member formed on the rotary member to be eccentric to the rotation center axis and the bending member bends the portion of the distal end of the orthodontic wire as the bending member is rotated while being in contact with the distal end of the orthodontic wire.
